(19) United States
(12) Patent Application Publication
(10) Pub. No.: US 2026/0160351 A1
(43) Pub. Date: Jun. 11, 2026

(54) PRESSURE RELIEF VALVE FOR ACOUSTIC INDUCED VIBRATION AND NOISE REDUCTION

(71) Applicant: Kiewit Corporation, Houston, TX (US)

(72) Inventors: Shahar Yoram, Sugar Land, TX (US); Elise Suzanne Torre, Houston, TX (US)

(21) Appl. No.: 19/410,577

(22) Filed: Dec. 5, 2025

Related U.S. Application Data
(60) Provisional application No. 63/729,780, filed on Dec. 9, 2024.

(51) Int. Cl. F16K 17/04; F16K 47/08

(52) U.S. Cl. CPC F16K 17/0433; F16K 47/08

(57) ABSTRACT

Some pressure relief valves (PRVs) may support reduction of acoustic induced vibration (AIV) and noise levels. For example, a PRV may include a flow splitting chamber that includes multiple first orifices that split a flow of fluid through a nozzle of the PRV, such that both a first level of AIV and a first level of noise associated with the multiple flows are less than a second level of AIV and a second level of noise, respectively, associated with the single flow. Additionally, or alternatively, the PRV may include multiple staged plates, each including one or more second orifices, such that both a third level of AIV and a third level of noise associated with the multiple pressure drops are less than a fourth level of AIV and a fourth level of noise, respectively, associated with a single pressure drop across the outlet chamber.

### CROSS REFERENCE

The present Application for Patent claims the benefit of U.S. Provisional Patent Application No. 63/729,780 by YORAM et al., entitled “PRESSURE RELIEF VALVE FOR ACOUSTIC INDUCE VIBRATION AND NOISE REDUCTION,” filed Dec. 9, 2024, assigned to the assignee hereof, and expressly incorporated by reference herein.

### FIELD OF TECHNOLOGY

The present disclosure relates generally to pressure relief valves (PRVs), and more specifically to PRVs for acoustic induced vibration (AIV) and noise reduction.

### BACKGROUND

Some pipe systems may experience Acoustic Induced Vibration (AIV) due to pressure drops across components of the pipe system, such as restriction orifice, manual and control valves, pressure relief valves (PRVs), or the like thereof. The AIV, specifically at Sounds Power Levels (PWLs) exceeding a threshold PWL, may lead to circumferential vibration in pipe walls, which may cause cycle fatigue failure in the pipe systems, specifically at asymmetric welded discontinuities, such as supports, fittings, and small-bore branch connections. Such failure may damage the pipe systems, which may lead to loss of containment of a fluid in the pipe system (e.g., gas), environmental damage, property damage, personal injury, loss of life, or any combination thereof.

Additionally, or alternatively, some pipe systems may produce noise due to the pressure drops across the components of the pipe systems. That is, a difference in pressure between the pipe system and ambient atmospheric pressure may result in sound pressure (e.g., or acoustic pressure, noise) which may be audible to the human ear based on an associated sound pressure level (SPL). Specifically, sound pressure at SPLs exceeding a threshold SPL, may result in sound pressure (e.g., noise) that may be audible to the human ear and may result in sensorineural acoustic trauma (e.g., damage or disruption to hearing), noise pollution, or both.

### SUMMARY

The systems, methods, and devices of this disclosure each have several innovative aspects, no single one of which is solely responsible for the desirable attributes disclosed herein.

A pressure relief valve (PRV) is described. The PRV may include a nozzle configured to direct a flow of fluid from an inlet of the nozzle towards an outlet of the nozzle, wherein a seat is positioned at the outlet of the nozzle, a disc system configured to move from a closed position to an open position based at least in part on a pressure at the inlet of the nozzle exceeding a threshold pressure, wherein at least a portion of an inner circumference of the disc system is positioned around at least a portion of an outer circumference of the nozzle, wherein the disc system is configured to restrict the fluid from flowing from the nozzle through a plurality of orifices in a flow splitting chamber in the closed position, and wherein the disc system is configured to allow the fluid to flow from the nozzle through the plurality of orifices in the flow splitting chamber in the open position, the disc system further comprising the flow splitting chamber comprising the plurality of orifices that are configured to split the flow of the fluid through the nozzle from a single flow to a plurality of flows when the disc system is in the open position, wherein both a first level of acoustic induced vibration and a first level of noise associated with the plurality of flows are less than a second level of acoustic induced vibration and a second level of noise, respectively, associated with the single flow and a disc positioned within the flow splitting chamber, and configured to contact the seat in the closed position and to be a threshold distance from the seat in the open position, wherein the threshold distance is based at least in part on a position of the plurality of orifices in the flow splitting chamber, a spring coupled to (e.g., coupled with) the disc system and configured to enable the disc system to move from the closed position to the open position based at least in part on movement of the spring due to a compressive force exceeding a threshold force when the pressure in the nozzle exceeds the threshold pressure, a stem coupled to the spring and configured to align the spring with the disc system, and an outlet chamber configured to direct flow from the plurality of orifices through an outlet of PRV when the disc system is in the open position.

In some examples of the PRV, a first area of the inlet of the nozzle may be within a threshold deviation of a sum of respective second areas of the plurality of orifices.

In some examples of the PRV, both the first level of acoustic induced vibration and the first level of noise associated with the plurality of flows being less than the second level of acoustic induced vibration and the second level of noise, respectively, associated with the single flow may be based at least in part on a distance between each of the plurality of orifices exceeding a threshold distance.

In some examples of the PRV, the plurality of orifices comprises one or more rows of orifices spaced vertically along a length of the flow splitting chamber and both the first level of acoustic induced vibration and the first level of noise associated with the plurality of flows may be based at least in part on a location of each of the one or more rows along the length of the flow splitting chamber.

In some examples of the PRV, a first distance between a first row of orifices of the one or more rows of orifices and a second row of orifices of the one or more rows of orifices may be different than a second distance between the second row of orifices and a third row of orifices of the one or more rows of orifices.

In some examples of the PRV, a first distance between a first row of orifices of the one or more rows of orifices and a second row of orifices of the one or more rows of orifices may be the same as a second distance between the second row of orifices and a third row of orifices of the one or more rows of orifices.

In some examples of the PRV, the plurality of orifices may be associated with a plurality of different sizes and both the first level of acoustic induced vibration and the first level of noise associated with the plurality of flows may be based at least in part on the plurality of different sizes.

In some examples of the PRV, one or more of the plurality of orifices across a length of the flow splitting chamber may have a different size compared to one or more other orifices of the plurality of orifices.

In some examples of the PRV, at least a subset of the plurality of orifices may be at a non-orthogonal angle relative to an outer surface of the flow splitting chamber and the first level of acoustic induced vibration associated with the plurality of flows may be based at least in part on the non-orthogonal angle relative to the outer surface of the flow splitting chamber.

In some examples of the PRV, the plurality of orifices may have one or more shapes including at least one of circular, square, hexagonal, oval, or triangular and both the first level of acoustic induced vibration and the first level of noise associated with the plurality of flows may be based at least in part on the one or more shapes of the plurality of orifices.

Some examples of the PRV may further include a balancing system configured to reduce movement of the PRV due to differences in first flow rates associated with the plurality of flows.

In some examples of the PRV, the balancing system comprises one or more pistons, one or more bellows, one or more diaphragms, or any combination thereof.

In some examples of the PRV, first flow rates associated with the plurality of flows may be the same.

In some examples of the PRV, the fluid may be a gas, a vapor, or a steam.

Another PRV is described. The PRV may include a nozzle configured to direct a flow of fluid from an inlet of the nozzle through an outlet of the nozzle, wherein a seat is positioned at the outlet of the nozzle, a disc system configured to move from a closed position to an open position based at least in part on a pressure of the fluid at the inlet of the nozzle exceeding a threshold pressure, wherein the closed position restricts the fluid from flowing from the nozzle to an outlet chamber, and wherein the open position allows the fluid to flow from the nozzle to the outlet chamber, a spring coupled to the disc system and configured to enable the disc system to move from the closed position to the open position based at least in part on movement of the spring due to a compressive force from a fluid exceeding a threshold force when the pressure of the fluid in the nozzle exceeds the threshold pressure, a stem coupled to the spring and configured to align the spring with the disc system, and an outlet chamber configured to direct flow from the nozzle through an outlet of the PRV when the disc system is in the open position, wherein the outlet chamber comprises a plurality of staged plates positioned across a length of the outlet chamber, wherein each staged plate from the plurality of staged plates comprises one or more orifices from a plurality of orifices, wherein each staged plate is associated with a respective pressure drop of the fluid from a plurality of pressure drops of the fluid, wherein both a first level of acoustic induced vibration and a first level of noise associated with the plurality of pressure drops are less than a second level of acoustic induced vibration and a second level of noise, respectively, associated with a single pressure drop across the outlet chamber.

In some examples of the PRV, both the first level of acoustic induced vibration and the first level of noise associated with the plurality of pressure drops may be based at least in part on a distance between each staged plate of the plurality of staged plates.

In some examples of the PRV, at least a subset of the plurality of orifices may be offset from each other and the plurality of pressure drops may be based at least in part on the plurality of orifices being offset from each other.

In some examples of the PRV, at least a subset of the plurality of orifices may have different sizes and the plurality of pressure drops may be based at least in part on the different sizes of at least the subset of the plurality of orifices.

In some examples of the PRV, the plurality of orifices change in size across a length of the outlet chamber.

In some examples of the PRV, the plurality of orifices may be associated with one or more shapes including at least one of circular, square, hexagonal, oval, or triangular and the plurality of pressure drops may be based at least in part on the one or more shapes.

In some examples of the PRV, at least a subset of the plurality of orifices may be at a non-orthogonal angle relative to a respective outer surface of a staged plate from the plurality of staged plates and the plurality of pressure drops may be based at least in part on the non-orthogonal angle.

In some examples of the PRV, at least a subset of the plurality of staged plates may be at a non-orthogonal angle relative to the outlet of the PRV.

In some examples of the PRV, a respective distance between each staged plate of at least a subset of the plurality of staged plates may be different.

In some examples of the PRV, a respective distance between each staged plate of at least a subset of the plurality of staged plates may be the same.

In some examples of the PRV, the fluid may be a gas, a vapor, or a steam.

Another PRV is described. The PRV may include a nozzle configured to direct a flow of fluid from an inlet of the nozzle through an outlet of the nozzle, wherein a seat is positioned at the outlet of the nozzle, a disc system configured to move from a closed position to an open position based at least in part on a pressure at the inlet of the nozzle exceeding a threshold pressure, wherein at least a portion of an inner circumference of the disc system is positioned around at least a portion of an outer circumference of the nozzle, wherein the disc system is configured to restrict the fluid from flowing from the nozzle through a plurality of first orifices in a flow splitting chamber in the closed position, and wherein the disc system is configured to allow the fluid to flow from the nozzle through the plurality of first orifices in the flow splitting chamber in the open position, the disc system further comprising the flow splitting chamber comprising the plurality of first orifices that are configured to split the flow of the fluid through the nozzle from a single flow to a plurality of flows when the disc system is in the open position, wherein both a first level of acoustic induced vibration and a first level of noise associated with the plurality of flows are less than a second level of acoustic induced vibration and a second level of noise, respectively, associated with the single flow and a disc positioned within the flow splitting chamber and configured to contact the seat in the closed position and to be a threshold distance from the seat in the open position, wherein the threshold distance is based at least in part on a position of the plurality of first orifices in the flow splitting chamber, a spring coupled to the disc system and configured to enable the disc system to move from the closed position to the open position based at least in part on movement of the spring due to a compressive force exceeding a threshold force when the pressure in the nozzle exceeds the threshold pressure, a stem coupled to the spring and configured to align the spring with the disc system, and an outlet chamber configured to direct flow from the nozzle through an outlet of the PRV when the disc system is in the open position, wherein the outlet chamber comprises a plurality of staged plates positioned across a length of the outlet chamber, wherein each staged plate from the plurality of staged plates comprises one or more second orifices from a plurality of second orifices, wherein each staged plate is associated with a respective pressure drop of the fluid from a plurality of pressure drops of the fluid, wherein both a third level of acoustic induced vibration and a third level of noise, associated with the plurality of pressure drops are less than a fourth level of acoustic induced vibration and a fourth level of noise, respectively, associated with a single pressure drop across the outlet chamber.

In some examples of the PRV, a distance between the flow splitting chamber and a first stage plate of the plurality of staged plates, a quantity of the plurality of second orifices, a quantity of the plurality of staged plates, or any combination thereof, may be based at least in part on one or more characteristics of the plurality of first orifices.

In some examples of the PRV, the one or more characteristics comprise a quantity of the plurality of first orifices, the position of the plurality of first orifices in the flow splitting chamber, one or more sizes associated with the plurality of first orifices, one or more shapes associated with the plurality of first orifices, or any combination thereof.

In some examples of the PRV, a quantity of the plurality of first orifices may be based at least in part on one or more first characteristics of the plurality of staged plates, one or more second characteristics of the plurality of second orifices, or both.

In some examples of the PRV, the one or more first characteristics comprise a quantity of the plurality of second orifices, respective positions of the plurality of second orifices, one or more sizes associated with the plurality of second orifices, one or more shapes associated with the plurality of second orifices, or any combination thereof and the one or more second characteristics comprise a quantity of the plurality of staged plates, respective positions of the plurality of staged plates, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A, 1B, and 1C show an example of a pressure relief value (PRV) that supports acoustic induced vibration (AIV) and sound power level (SPL) reduction in accordance with aspects of the present disclosure.

FIGS. 2A and 2B show an example of a PRV that supports AIV and SPL reduction in accordance with aspects of the present disclosure.

FIG. 3 shows an example of a PRV that supports AIV and SPL reduction in accordance with aspects of the present disclosure.

FIGS. 4A and 4B show an example of a PRV that supports AIV and SPL reduction in accordance with aspects of the present disclosure.

### DETAILED DESCRIPTION

Some pipe systems, specifically gas service piping, may experience Acoustic Induced Vibration (AIV) and noise (e.g., sound pressure). That is, a pressure drop exceeding a threshold pressure drop (e.g., a high pressure drop) across one or more components of a pipe system, such as restriction orifices, manual and control valves, pressure relief values (PRVs), or the like thereof, in combination with a flow rate exceeding a threshold flow rate (e.g., a large flow rate), may cause vibration (e.g., AIV) due to energy induced in the pipe system. In such cases, the vibration may be broadband vibration that achieves resonance at multiple (e.g., all or nearly all) frequencies. Additionally, AIV, specifically at Sound Power Levels (PWLs) exceeding a threshold PWL (e.g., high PWLs), measured in decibels (dBs) at one or more octave band frequencies, may lead to frequency circumferential vibration in pipe walls, which may cause cycle fatigue failure in the pipe system, specifically at asymmetric welded discontinuities, such as supports, fittings, and small-bore branch connections. Such failure may damage the pipe system, which may lead to loss of containment of a fluid in the pipe system (e.g., gas), environmental damage, property damage, personal injury, loss of life, or any combination thereof. Thus, in order to mitigate the effect of AIV and noise, rather than directing fluid (e.g., a high relief load) through a single PRV, the fluid may be divided across multiple (e.g., additional), smaller PRVs (e.g., as compared to the single PRV). That is, rather than directing a flow (e.g., of the substance in the pipe system) through 2 large PRVs (e.g., 6Q8 PRVs), the flow may be divided across 6 or 7 smaller PRVs (e.g., 4M6 PRVs). However, increasing the quantity of PRVs, decreasing a size of PRVs, or both, may result in increases to total install costs and design and construction complexity, particularly in brown field work.

Additionally, or alternatively, the pressure drop across the one or more components of the pipe system may result in noise (e.g., sound pressure) associated with a Sound Pressure Level (SPL), measured in dBs at one or more octave band frequencies and/or measured as a weighted measurement for human consumption, which may be referred to as A-weighted dB (dBA). That is, a difference in pressure between the pipe system and ambient atmospheric pressure may result in sound pressure (e.g., or acoustic pressure, noise) which may be audible to a human ear based on the associated SPL. Thus, the pressure drop across the one or more components of the pipe system exceeding the threshold pressure drop may result in noise (e.g., sound pressure) at an SPL that exceeds a threshold SPL (e.g., high SPLs, SPLs exceeding regulatory permissible SPL values), which may result in sensorineural acoustic trauma (e.g., damage or disruption to hearing), noise pollution, or both.

Accordingly, techniques described herein may support AIV reduction (e.g., PWL reduction), noise reduction (e.g., SPL reduction), or both, in PRVs. In some cases, a PRV may include a flow splitting chamber including multiple first orifices that split a flow of fluid through a nozzle of the PRV from a single flow to multiple flows when a disc system of the PRV is in an open position. For example, the PRV may include one or more components that enable a disc system of the PRV to move from the closed position (e.g., restricting flow through the PRV) to an open position (e.g., allowing flow through the PRV). In some cases, the PRV may be a spring loaded PRV where the one or more components includes at least a spring coupled to the disc system that enables the disc system to move from the closed position to the open position based on movement of the spring (e.g., compression of the spring). In such cases, movement of the spring may be due to a compressive force exceeding a threshold force, where the threshold force is associated with a pressure in a nozzle of the PRV exceeding a threshold pressure (e.g., set pressure). In some other cases, the PRV may be a pilot-operated PRV (POPRV) that includes a control pilot system that enables the disc system (e.g., piston) to move from the closed position to the open position. In either case, the disc system may include the flow splitting chamber such that the fluid may flow through the multiple first orifices when the disc system is in the open position and may be restricted from flowing (e.g., may not flow) through the multiple first orifices when the disc system is in the closed position. In such cases, splitting the flow of the fluid through the PRV from a single flow to the multiple flows may reduce AIV and noise generated by the flow of the fluid through the PRV (e.g., as compared to the single flow).

Additionally, or alternatively, the PRV may include multiple staged plates positioned (e.g., in series) across a length of an outlet chamber of the PRV, where each plate includes one or more second orifices (e.g., from multiple second orifices associated with the multiple staged plates). In other words, the multiple staged plates may direct the flow of the fluid across the outlet chamber through the multiple second orifices. In such cases, each staged plate may be associated with a respective pressure drop of the fluid (e.g., from multiple pressure drops of the fluid) based on one or more respective second orifices. That is, rather than support a single pressure drop of the fluid across the outlet chamber (e.g., without the multiple staged plates), the multiple staged plates may drop a pressure of the fluid incrementally across each staged plate of the multiple staged plates. In such cases, dropping the pressure of the fluid incrementally via multiple pressure drops across each staged plate of the multiple plates may reduce AIV and noise generated by the flow of the fluid through the PRV (e.g., as compared to the single pressure drop).

In some cases, the PRV may include both the flow splitting chamber (e.g., including the multiple first orifices) and the multiple staged plates (e.g., including the multiple second orifices), such that a reduction in AIV and noise (e.g., associated with the PRV) is based on both the splitting of the flow via the flow splitting chamber and based on the incremental pressure drop via the multiple staged plates.

Aspects of the disclosure are described in the context of PRVs. This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a PRV to additionally, or alternatively, solve other problems than those described herein. Further, aspects of the disclosure may provide technical improvements to “conventional” systems or processes as described herein. However, the description and appended drawings include example technical improvements resulting from implementing aspects of the disclosure, and accordingly do not represent all of the technical improvements provided within the scope of the claims.

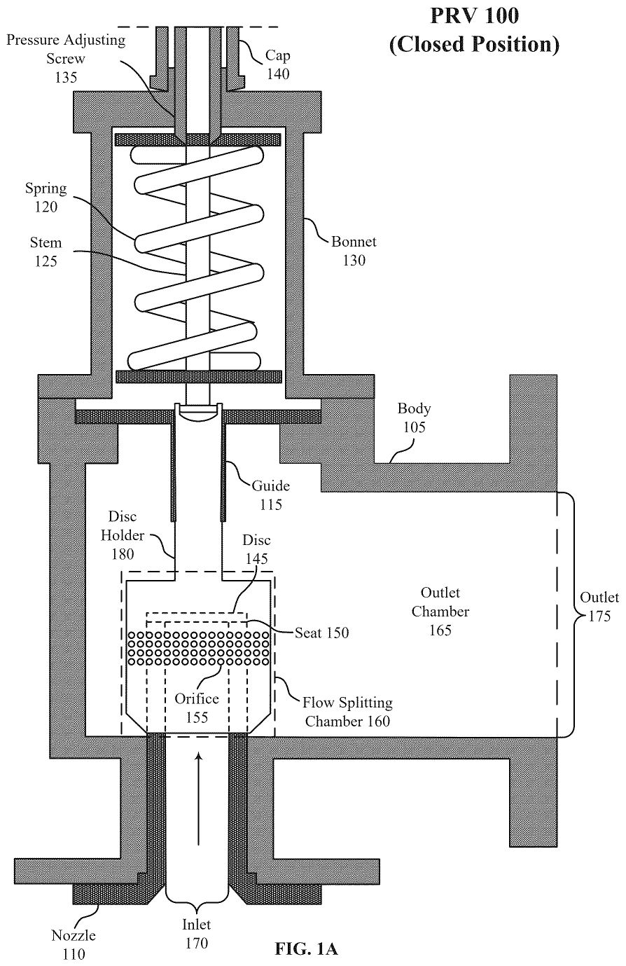

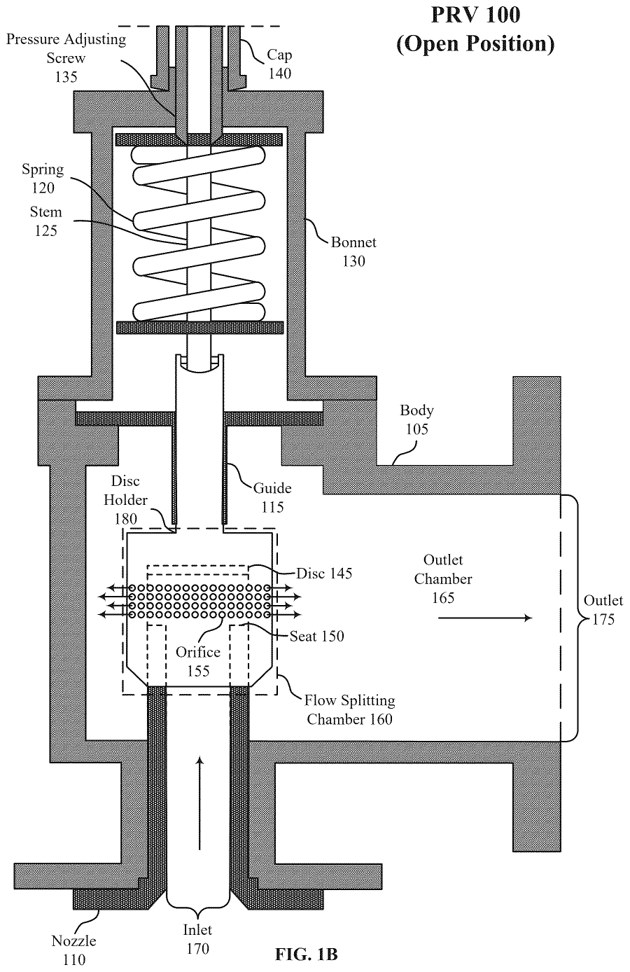

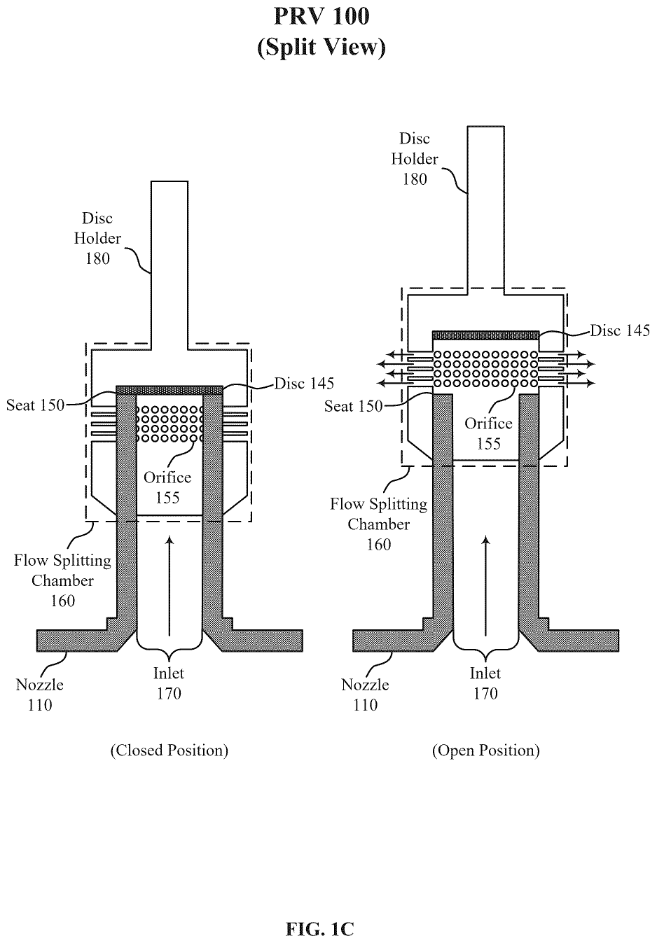

FIGS. 1A, 1B, and 1C show an example of a PRV 100 that supports AIV and noise reduction in accordance with aspects of the present disclosure. That is, the PRV 100 may be a spring-loaded PRV 100 that includes a flow splitting chamber 160 including multiple orifices 155 that split a flow of fluid through a nozzle 110 of the PRV 100 from a single flow to multiple flows when a disc system of the PRV 100 is in an open position.

For example, the PRV 100 may include a body 105 connected to a nozzle 110, where the nozzle 110 directs the flow of the fluid into the PRV 100 through an inlet 170. The PRV 100 may additionally include a disc system, where the disc system includes a disc holder 180 and a disc 145. In such cases, a portion of the disc holder 180 including multiple orifices 155 may be referred to as a flow splitting chamber 160, and the nozzle 110 may sit at least partially within a cavity of the flow splitting chamber 160 (e.g., disc holder 180), as depicted in FIG. 1C. In other words, the flow splitting chamber 160 may include a cavity defined by an inner surface, such that the inner surface of the cavity contacts an outer surface of the nozzle 110 (e.g., within a threshold tolerance). Thus, at least a portion of the nozzle 110 may be positioned within the flow splitting chamber 160. Additionally, a disc 145 may be connected to the disc holder 180 within the cavity. That is, the disc 145 may connect to the disc holder 180 at a top surface of the cavity.

Thus, when the disc system of the PRV 100 is in the closed position, as depicted in FIG. 1A, the disc 145 may contact a top surface of the nozzle 110, where the top surface of the nozzle 110 may be referred to as a seat 150. In the closed position, the disc system may restrict the flow of the fluid from the nozzle 110, through the multiple orifices 155, to an outlet chamber 165 based on the disc 145 contacting the seat 150.

In some cases, the disc system may move from the closed position, as depicted in FIG. 1A, to an open position, as depicted in FIG. 1B, based on a pressure of the fluid at the inlet 170 (e.g., inlet pressure) exceeding a threshold pressure (e.g., a set pressure). That is, a bonnet 130 of the PRV 100 may include a spring 120 aligned with the disc holder 180 (e.g., via a stem 125 and a guide 115), such that the spring 120 may apply a first force (e.g., based on the threshold pressure) to the disc system (e.g., disc holder 180) in a first direction (e.g., downward) causing the disc 145 to contact the seat 150 (e.g., and create a seal). However, the fluid may exert a second force to the disc system (e.g., to the disc 145 and thus the disc holder 180) in a second direction (e.g., upward), opposite the first direction, based on the pressure of the fluid. Thus, when the pressure of the fluid is less than or equal to the threshold pressure, the first force exerted by the spring 120 may be greater than or equal to the second force exerted by the fluid (e.g., due to the pressure of the fluid), keeping the disc system in the closed position in which the disc 145 contacts the seat 150. Conversely, when the pressure of the fluid exceeds the threshold pressure, the second force exerted by the fluid may be greater than the first force exerted by the spring 120, causing the spring 120 to move (e.g., compress), which further causes the disc system to lift (e.g., move in the second direction) to the open position in which the disc 145 no longer contacts the seat 150 (e.g., the disc 145 is at a distance from the seat 150). Further, when the pressure of the fluid at the inlet 170 returns to (e.g., is reduced to) being below the threshold pressure (e.g., set pressure), the disc 145 may re-close (e.g., the PRV 100 may re-close, the disc system may return to an initial position, as depicted in FIG. 1A). In such cases, the threshold pressure (e.g., corresponding to the first force exerted by the spring 120) may be based on (e.g., may be set by) a pressure adjusting screw 135 in a cap 140 of the PRV 200. That is, the pressure adjusting screw 135 may adjust the first force applied by the spring 120 to the disc system, which may correspond to the threshold pressure (e.g., set pressure).

Thus, when the disc system is in the open position, the fluid may flow from the nozzle 110, through the multiple orifices 155 in the flow splitting chamber 160, to the outlet chamber 165 (e.g., and out of the PRV 100 through the outlet 175). In other words, to transition to the open position, the disc system may move (e.g., lift) a distance exceeding a first threshold distance such that the multiple orifices 155 may be positioned above the seat 150, allowing the flow of the fluid through the multiple orifices 155. In such cases, the first threshold distance may be based on a position of the multiple orifices 155 in the flow splitting chamber 160 (e.g., relative to the disc holder 180, the seat 150, or both). That is, in the open position, the disc system may lift up enough (e.g., more than first threshold distance) to allow the multiple orifices 155 to be positioned above the seat 150. Additionally, the distance that the disc system moves may be less than a second threshold distance, where the second threshold distance is based on a length of the disc holder 180. That is, in the open position, the disc system may be restricted from lifting up too much (e.g., less than the second threshold distance) to avoid the entire disc holder 180 from moving above the seat 150.

In such cases, movement of the disc system more than the first threshold distance but less than the second threshold distance may be based on a length of the guide 115. That is, the length of the guide 115 may be within a range of lengths, where a shortest length in the range of lengths is associated with the entire disc holder 180 being positioned above the seat 150 and a longest length in the range of lengths is associated with at least a subset of the multiple orifices 155 being positioned below the seat 150. In other words, the guide 115 may be long enough to allow the disc system to lift and position at least a subset of the multiple orifices 155 above the seat 150, but be short enough to keep the entire disc system from lifting above the seat 150.

As discussed above, in the open position, the flow of fluid through the nozzle 110 (e.g., a single flow of fluid) may split into multiple flows of fluid through the multiple orifices 155. In such cases, splitting the flow of the fluid from the single flow (e.g., through the nozzle 110) to the multiple flows (e.g., through the multiple orifices 155) may reduce AIV in a pipe system including the PRV 100. That is, as described herein, the effects (e.g., and strength) of AIV may be based on a PWL of the AIV, which may be calculated according to according to the following Equation 1:

$$P W L = 10 {log}_{10} [ {( \frac{{P}_{1} - {P}_{2}}{{P}_{1}} )}^{3.6} \times {W}^{2} \times {( \frac{T e}{M w} )}^{1.2} ] + 45 + S S F \qquad ( 1 )$$

where the parameter PWL may represent the PWL at a pressure reducing device (PRD) (e.g., the PRV 100) in dB, the parameter P₁ may represent a pressure upstream of the PRD in pounds per square in absolute (psia), the parameter P₂ may represent a pressure downstream of the PRD in psia, the parameter W may represent a mass flow rate through the PRD in pounds per hour (lb./h), the parameter Te may represent a temperature upstream of the PRD in Rankine (° R), the parameter Mw may represent a molecular weight of the fluid through the PRD in grams per mole (g/mol), and the parameter SSF may represent a correction factor for sonic flow. In such cases, the parameter SSF may equal 6 if the flow is sonic, otherwise, the parameter SSF may equal 0. Thus, splitting the flow through the multiple orifices 155 (e.g., splitting a single flow rate into multiple flow rates) may reduce the PWL, as compared to the single flow (e.g., the single flow rate), which may reduce the AIV associated with the PRV 100. Similarly, splitting the flow through the multiple orifices 155 may reduce an SPL (e.g., associated with noise, or sound pressure, produced by the PRV 100), as compared to a single flow, which may reduce noise (e.g., sound pressure) produced by the PRV 100.

Though depicted as multiple rows of circular orifices 155, this is not to be regarded as a limitation of the present disclosure. In this regard, any design of the multiple orifices 155 may be supported with regards to the techniques described herein. For example, the flow splitting chamber 160 (e.g., of the disc holder 180) may include one or more rows of orifices 155. In such cases, the one or more rows may include a same quantity (e.g., and/or size) of orifices 155 in each row, a different quantity (e.g., and/or size) of orifices 155 in each row, or both. Additionally, or alternatively, the one or more rows of orifices 155 may be equally spaced, non-equally (e.g., variably) spaced, or both. Additionally, or alternatively, the multiple orifices may be associated with one or more sizes of orifices 155, one or more shapes of orifices 155 (e.g., circular, square, hexagonal, oval, triangular, or the like thereof), one or more angles of orifices 155, or any combination thereof. For example, the multiple orifices 155 may increase in size (e.g., or decrease in size) along a length of the flow splitting chamber 160. Additionally, or alternatively, one or more orifices 155 of the multiple orifices 155 may be at a non-orthogonal angle relative to an outer surface of the flow splitting chamber, an inner surface of the flow splitting chamber, or both.

In some cases, the design of the multiple orifices 155 may be based on one or more characteristics associated with the disc 145 lifting off of the seat 150 (e.g., of the nozzle 110). For example, the disc 145 lifting off of the seat 150 at a constant speed may be associated with the flow splitting chamber 160 including a first quantity of the multiple orifices 155 and the disc 145 lifting off of the seat 150 at a variable speed (e.g., the spring 120 is a variable spring 120) may be associated with the flow splitting chamber 160 including a second quantity of the multiple orifices 155.

In some cases, a total flow area of the PRV 100 may be equal to (e.g., within a threshold tolerance of) a sum of areas of the multiple orifices 155. Additionally, or alternatively, the sum of the areas of the multiple orifices 155 may be based on (e.g., greater than, equal to, or less than) an area of the inlet 170, the outlet 175, or both.

Additionally, or alternatively, a distance between the multiple orifices 155 may be greater than a third threshold distance, less than a fourth threshold distance, or both. That is, if a distance between two orifices 155 is too short (e.g., less than the third threshold distance) or too long (e.g., greater than the fourth threshold distance), the flow splitting chamber 160 may not split the flow of the fluid through the multiple orifices 155 in a way that achieves AIV reduction (e.g., optimal AIV reduction) and noise reduction.

In some cases, the PRV 100 may additionally include a balancing system to reduce movement of the PRV 100, one or more components of the PRV 100, or both, based on differences in the multiple flow rates associated with the multiple flows. That is, flow rates associated with each orifice 155 of the multiple orifices 155 may be different, such that the disc system may become unbalanced and move in an undesired direction (e.g., a non-parallel direction to the length of the disc system). Thus, the balancing system may reduce or prevent the movement in the undesired direction. For example, the balancing system may include one or more pistons, one or more bellows, one or more diaphragms, or any combination thereof.

Additionally, or alternatively, one or more designs of one or more components of the PRV 100 may be based on the flow splitting chamber 160, the multiple orifices 155, or both. In such cases, the one or more components may include, but are not limited to, the nozzle 110, the inlet 170, the outlet 175, the spring 120, the threshold pressure (e.g., the pressure adjusting screw 135), the body 105 (e.g., spacing of the body 105), the disc 145 (e.g., a shape of the disc 145), the stem 125, the seat 150 (e.g., a shape of the seat 150), or any combination thereof.

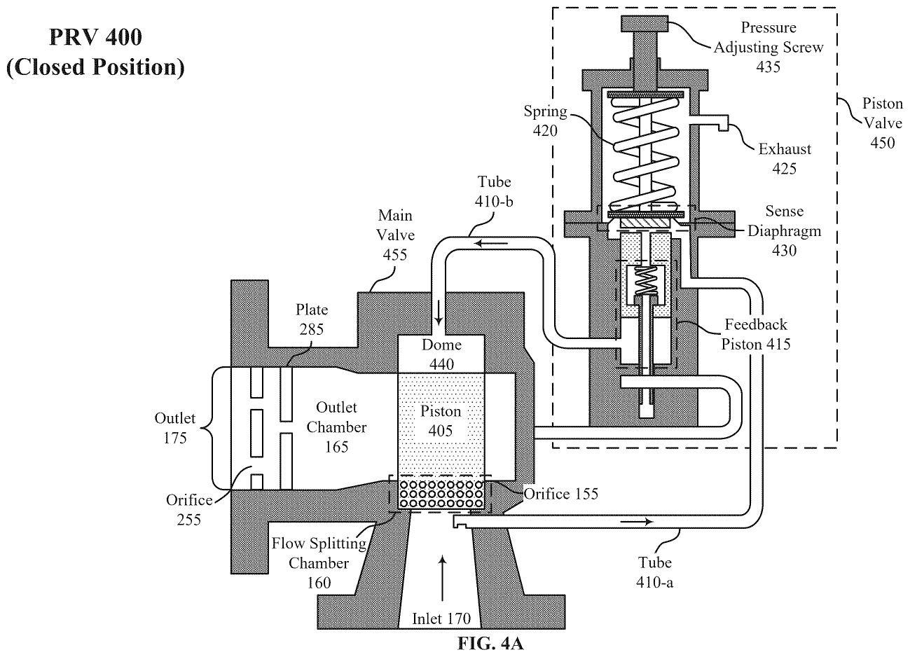

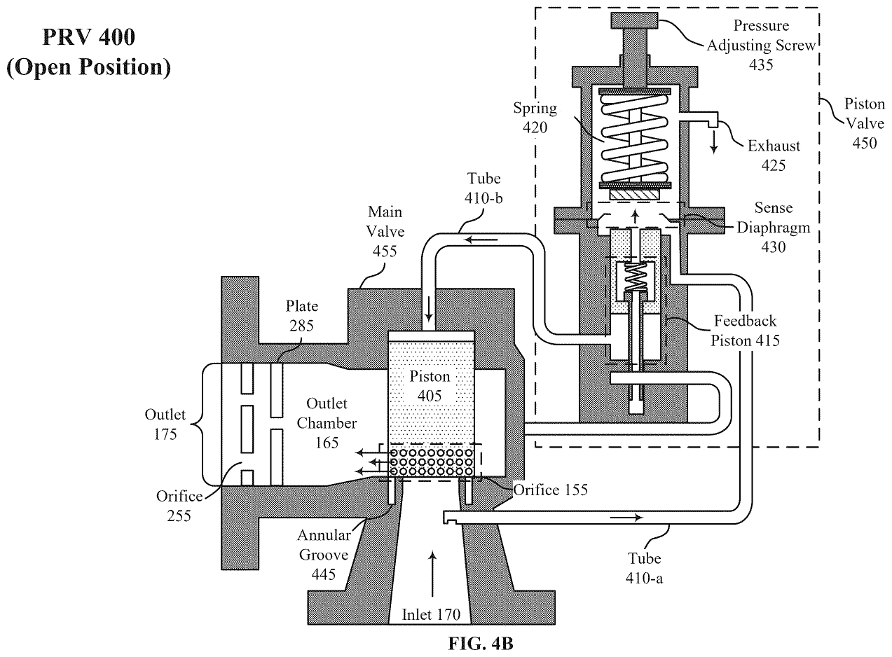

Though described in the context of a spring-loaded PRV 100, this is not to be regarded as a limitation of the present disclosure. In this regard, the techniques described herein may be supported by any type of PRV including, but not limited to, spring-loaded PRVs, POPRVs (e.g., as described with reference to FIGS. 4A and 4B), or the like thereof.

As used herein, the following phrases associated with AIV may be synonymous: AIV reduction, a reduction in AIV, a reduction in a level of AIV, and a reduction in a PWL associated with the AIV. Similarly, the following phrases associated with noise may be synonymous: noise reduction, a reduction in noise, a reduction in a level of noise, a reduction in an SPL associated with the noise. Additionally, or alternatively, the term noise and sound pressure may be used interchangeably.

Though described in the context of AIV reduction and noise reduction, this is not to be regarded as a limitation of the present disclosure. In this regard, other results (e.g., advantages) may additionally, or alternatively, be achieved with regards to the techniques described herein.

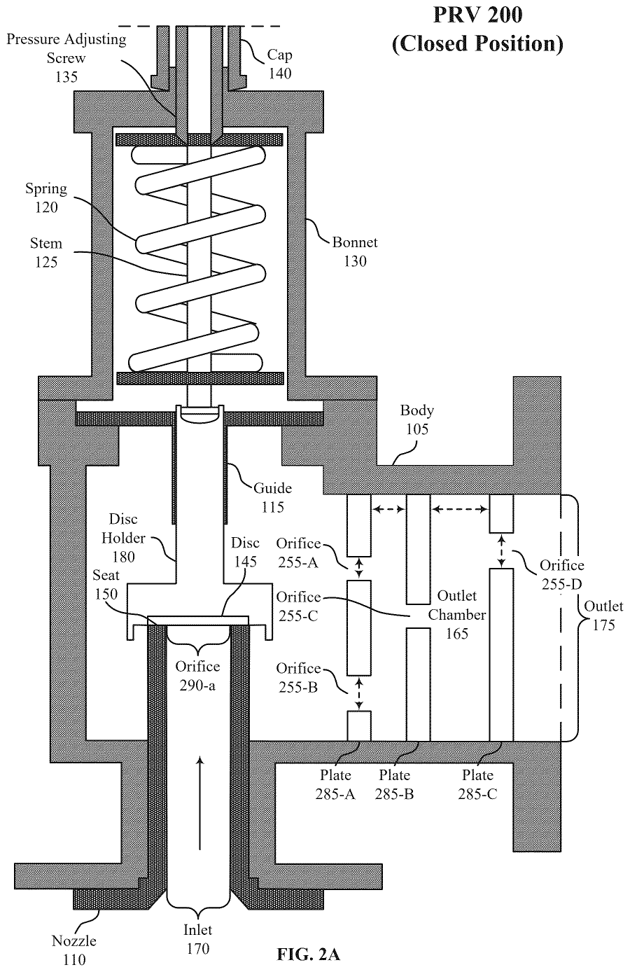

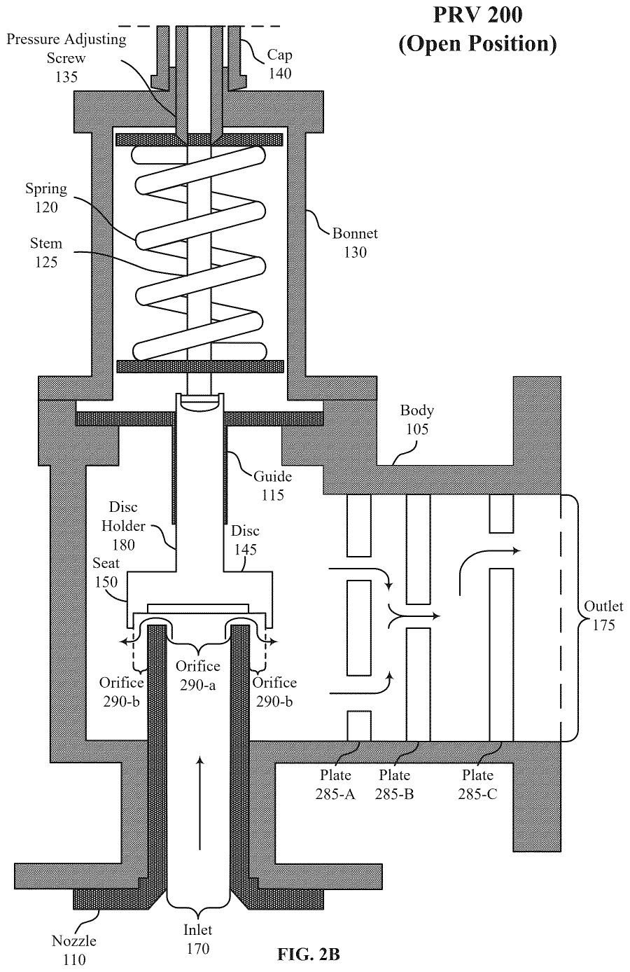

FIGS. 2A and 2B show an example of a PRV 200 that supports AIV and noise reduction in accordance with aspects of the present disclosure. That is, the PRV 200 may be a spring-loaded PRV 100 that includes multiple plates 285 (e.g., staged plates 285) positioned across a length of an outlet chamber 165 of the PRV 200 to incrementally drop a pressure of fluid flowing through the PRV 200 in multiple stages (e.g., across each plate 285).

For example, the PRV 200 may include a body 105 connected to a nozzle 110, where the nozzle 110 directs the flow of the fluid into the PRV 200 through an inlet 170. The PRV 200 may additionally include a disc system further including a disc 145 connected to a disc holder 180. When the disc system of the PRV 200 is in a closed position, as depicted in FIG. 2A, the disc 145 may contact a top surface of the nozzle 110, which may be referred to as a seat 150 of the nozzle 110, such that the disc system may restrict fluid from flowing from the inlet 170 to an outlet chamber 165 based on the disc 145 contacting the seat 150.

In some cases, the disc system may move from the closed position, as depicted in FIG. 2A, to an open position, as depicted in FIG. 2B, based on a pressure of the fluid at the inlet 170 (e.g., inlet pressure) exceeding a threshold pressure (e.g., a set pressure). That is, a bonnet 130 of the PRV 200 may include a spring 120 aligned with the disc holder 180 (e.g., via a stem 125 and a guide 115), such that the spring 120 may apply a first force (e.g., based on the threshold pressure) to the disc system (e.g., disc holder 180) in a first direction causing the disc 145 to contact the seat 150 (e.g., and create a seal). However, the fluid may exert a second force to the disc system (e.g., to the disc 145 and thus the disc holder 180) in a second direction, opposite the first direction, based on the pressure of the fluid. Thus, when the pressure of the fluid is less than or equal to the threshold pressure, the first force exerted by the spring 120 may be greater than or equal to the second force exerted by the fluid (e.g., due to the pressure of the fluid), keeping the disc system in the closed position in which the disc 145 contacts the seat 150. Conversely, when the pressure of the fluid exceeds the threshold pressure, the second force exerted by the fluid may be greater than the first force exerted by the spring 120, causing the spring 120 to move (e.g., compress), which further causes the disc system to lift to the open position in which the disc 145 no longer contacts the seat 150 (e.g., the disc 145 is at a distance from the seat 150). Further, when the pressure of the fluid at the inlet 170 returns to (e.g., is reduced to) being below the threshold pressure (e.g., set pressure), the disc 145 may re-close (e.g., the PRV 200 may re-close). In such cases, the threshold pressure (e.g., corresponding to the first force exerted by the spring 120) may be based on (e.g., may be set by) a pressure adjusting screw 135 in a cap 140 of the PRV 200. Thus, when the disc system is in the open position, the fluid may flow through an orifice 290-a in the nozzle 110 and through an orifice 290-b between an outer surface of the nozzle 110 and the disc holder 180 to an outlet chamber 165.

The PRV 200 may additionally include multiple (e.g., one or more) plates 285 in the outlet chamber 165 through which the fluid may flow, such as a plate 285-a, a plate 285-b, and a plate 285-c. That is, each plate 285 may include one or more orifices 255 through which the fluid may flow (e.g., when the PRV 200 is in the open position). For example, the plate 285-a may include an orifice 255-a and an orifice 255-b, the plate 285-b may include an orifice 255-c, and the plate 285-c may include an orifice 255-d. Thus, a pressure of the fluid in the PRV may drop incrementally across each plate 285, rather than in a single pressure drop across the length of the outlet chamber 165 (e.g., when the one or more plates 285 are not present). In such cases, incrementally dropping the pressure of the fluid via the multiple plates 285 may reduce AIV (e.g., a level of AIV, a PWL associated with the AIV) and noise (e.g., a level of noise, a noise level, an SPL associated with the noise) in a pipe system including the PRV 200. That is, as described herein with reference to FIGS. 1A, 1B, and 1C, the effects (e.g., and strength) of AIV may be based on a PWL associated with the AIV, which may be calculated according to according to Equation 1. Thus, dropping the pressure of the fluid in increments may reduce the PWL, as compared to the single pressure drop (e.g., without the plates 285), which may reduce the AIV associated with the PRV 200. That is, each plate 285 may be associated with a PWL based on a respective pressure drop across the plate 285, where a sum of the PWLs associated with each plate 285 may be less than a single PWL associated with a single pressure drop across the outlet chamber 165 (e.g., when no plates 285 are present). Similarly, dropping the pressure of the fluid in increments may reduce an SPL (e.g., associated with noise, or sound pressure, produced by the PRV 200), as compared to a single flow, which may reduce noise (e.g., sound pressure) produced by the PRV 200.

In some cases, the multiple plates 285 may include a same quantity of orifices 255 in each plate 285, a different quantity of orifices 255 in each plate 285, or both. For example, the plate 285-a may include two orifices 255 while each of the plate 285-b and the plate 285-c may include a single orifice 255. Additionally, or alternatively, an orifice 255 in a plate 285 may be offset from one or more other orifices 255 in one or more other plates 285. For example, the orifice 255-a may be offset from the orifice 255-c and the orifice 255-d. Conversely (e.g., not depicted), an orifice 255 in a plate 285 may align with one or more other orifices 255 in one or more other plates 285.

Additionally, or alternatively, at least a first subset of the plates 285 may be unequally spaced across the outlet chamber 165. That is, a respective distance between each plate 285 of the at least first subset of the plates 285 may be different. For example, a first distance between the plate 285-a and the plate 285-b may be smaller than a second distance between the plate 285-b and the plate 285-c. Additionally, or alternatively, at least a second subset of the plates 285 may be equally spaced across the outlet chamber 165. That is, a respective distance between each plate 285 of the at least second subset of the plates 285 may be the same. For example, (e.g., not depicted), the first distance may be the same as the second distance.

Additionally, or alternatively, a distance between the plates 285 may be greater than a first threshold distance, less than a second threshold distance, or both. That is, if a distance between two plates 285 is too short (e.g., less than the first threshold distance) or too long (e.g., greater than the second threshold distance), the plates 285 may incrementally drop a pressure of the fluid in a way that does not achieve AIV reduction (e.g., optimal AIV reduction) and noise reduction.

Additionally, or alternatively, at least a subset of the orifices 255 in the plates 285 may be at a non-orthogonal angle relative to an outer surface of a respective plate 285, at least a third subset of the plates 285 may be at a non-orthogonal angle relative to the outlet 175, or both. Additionally, or alternatively, the orifices 255 in the plates 285 may be associated with one or more shapes (e.g., circular, square, hexagonal, oval, or triangular), one or more sizes (e.g., diameters, areas), or both. For example, the orifice 255-a may be smaller (e.g., in diameter) than the orifice 255-b and the orifice 255-d.

Though described in the context of a spring-loaded PRV 200, this is not to be regarded as a limitation of the present disclosure. In this regard, the techniques described herein may be supported by any type of PRV including, but not limited to, spring-loaded PRVs, POPRVs (e.g., as described with reference to FIGS. 4A and 4B), or the like thereof.

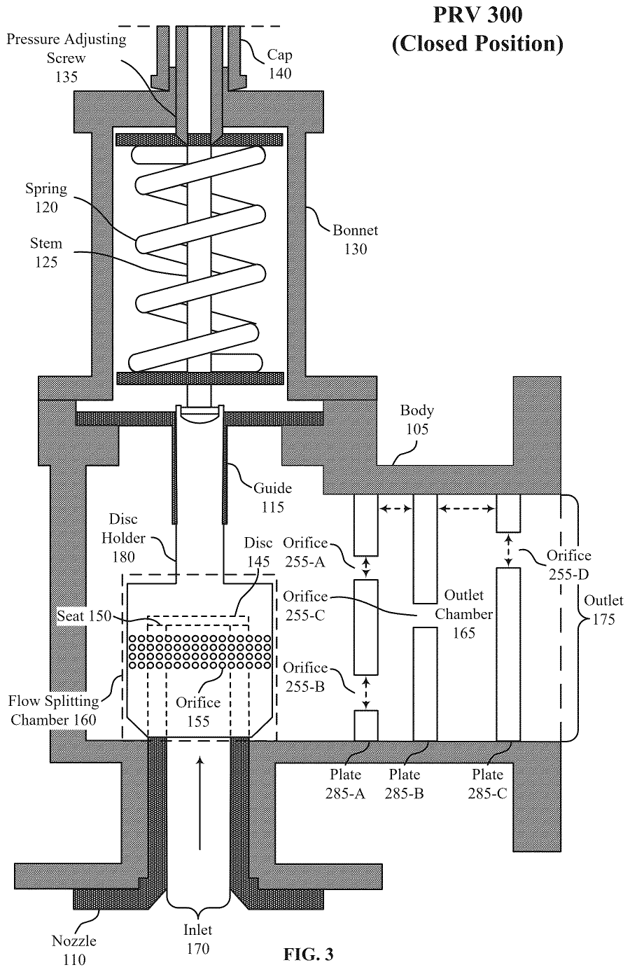

FIG. 3 shows an example of a PRV 300 that supports AIV and noise reduction in accordance with aspects of the present disclosure. That is, the PRV 300 may be a spring-loaded PRV 300 that includes a flow splitting chamber 160 including multiple orifices 155 that split a flow of fluid through a nozzle 110 of the PRV 300, as described with reference to FIGS. 1A, 1B, and 1C, and multiple plates 285 (e.g., staged plates 285) positioned across a length of an outlet chamber 165 of the PRV 300, as described with reference to FIGS. 2A and 2B. Thus, the PRV 300 may achieve AIV and noise reduction through the combination of splitting the flow of the fluid through a nozzle 110 from a single flow to multiple flows and incrementally dropping a pressure of the fluid flowing through the PRV 300 in multiple stages across each plate 285 (e.g., when a disc system of the PRV 300 is in an open position, not depicted).

In such cases, one or more first characteristics of the flow splitting chamber 160 (e.g., including the orifices 155) may be based on one or more second characteristics of the multiple plates 285, and visa-versa. The one or more first characteristics may include one or more sizes of the orifices 155, one or more shapes of the orifices 155, one or more spacings of (e.g., distances between) the orifices 155, a quantity of rows of the orifices 155, a position (e.g., location) of the orifices 155 on the flow splitting chamber 160, a quantity of the orifices 155, or any combination thereof. The one or more second characteristics may include a quantity of the orifices 255, a position of one or more of the orifices 255 (e.g., relative to the flow splitting chamber 160, relative to a respective plate 285, or both), one or more sizes of the orifices 255, one or more shapes of the orifices 255, a quantity of the plates 285, a location of one or more of the plates 285 (e.g., relative to the flow splitting chamber 160, relative to the outlet chamber 165), one or more spacings of the plates 285, or any combination thereof.

For example, a distance between the flow splitting chamber and a plate 285-a (e.g., a first plate 285) may be based on the one or more first characteristics of the flow splitting chamber 160, the one or more second characteristics of the plates 285, or both. As an illustrative example, if the flow splitting chamber 160 includes 2 rows of orifices and the plate 285-a includes two orifices 255, the plate 285-a may be positioned at a first distance from the flow splitting chamber 160, while if the flow splitting chamber includes 2 rows of orifices and the plate 285-a includes one orifice 255, the plate 285-a may be positioned at a second distance from the flow splitting chamber 160.

Though described in the context of a spring-loaded PRV 300, this is not to be regarded as a limitation of the present disclosure. In this regard, the techniques described herein may be supported by any type of PRV including, but not limited to, spring-loaded PRVs, POPRVs (e.g., as described with reference to FIGS. 4A and 4B), or the like thereof.

FIGS. 4A and 4B show an example of a PRV 400 that supports AIV and noise reduction in accordance with aspects of the present disclosure. In some cases, the PRV 400 may be a POPRV 400. That is, the PRV 400 may be a PRV 400 in which a main valve 455 (e.g., major relieving device) is combined with (e.g., and controlled by) a pilot valve 450 (e.g., self-actuated auxiliary PRV), where the main valve 450 may enclose a floating unbalanced piston assembly (e.g., including a feedback piston 415). Additionally, as described herein, the POPRV 400 may support AIV and noise reduction. That is, the PRV 400 may be a POPRV 400 that includes a flow splitting chamber 160 including multiple orifices 155 that split a flow of fluid through a nozzle 110 of the PRV 300, as described with reference to FIGS. 1A, 1B, and 1C, multiple plates 285 (e.g., staged plates 285) positioned across a length of an outlet chamber 165 of the PRV 400, as described with reference to FIGS. 2A and 2B, or both. Thus, the PRV 400 may achieve AIV and noise reduction through one or both of splitting the flow of the fluid through a nozzle 110 from a single flow to multiple flows or incrementally dropping a pressure of the fluid flowing through the PRV 300 in multiple stages across each plate 285 (e.g., when a piston 405 of the PRV 400 is in an open position, as depicted in FIG. 4B).

For example, the PRV 400 may include the main valve 455 (e.g., main valve), with an inlet 170 and an outlet 175, connected to a pilot valve 450 (e.g., control pilot, pilot system) via multiple tubes 410 (e.g., pilot tubes), such as a tube 410-a and a tube 410-b, where the pilot valve 450 includes, at least, a feedback piston 415, a spring 420, an exhaust 425, a sense diaphragm 430, and a pressure adjusting screw 435. The PRV 400 may further include (e.g., in the main valve 455) a piston 405 with a flow splitting chamber 160, where the flow splitting chamber 160 includes multiple orifices 155, as described with reference to FIGS. 1A, 1B, and 1C.

In a closed position, as depicted in FIG. 4A, a portion of the piston 405 including the flow splitting chamber 160 (e.g., including the orifices 155) may be positioned within one or more annular grooves 445 (e.g., a single annular groove 445, as depicted in FIG. 4B) in the main valve 455 of the PRV 400, such that fluid is restricted from flowing (e.g., may not flow) from the inlet 170 through the multiple orifices 155 to the outlet chamber 165. That is, the fluid may enter the PRV 400 through the inlet 170 and at least a portion of the fluid may flow from the inlet 170 through the tube 410-a to the pilot valve 450, and further through the tube 410-b to a dome 440 above the piston 405 (e.g., on an opposite side of the piston 405 than the inlet 170). In the closed position, a pressure of the fluid (e.g., at the inlet 170, in the dome 440, in the pilot valve 450) may be less than a threshold pressure (e.g., set pressure), as set by the pressure adjusting screw 435, such that the sense diaphragm 430 may remain in a closed position, restricting the fluid from flowing to the exhaust 425. Thus, the fluid in the dome 440 may exert a force on the piston 405 (e.g., based on the pressure of the fluid) that causes the piston 405 to remain in the closed position in which the portion of the piston 405 (e.g., including the orifices 155) is positioned within the one or more annular grooves 445, restricting the fluid from flowing through the orifices 155. In other words, in the closed position, the fluid in the dome 440 may be associated with a same pressure as the fluid in the inlet 170 (e.g., inlet pressure), however, a first surface area (e.g., area) of a top of the piston 405 may be greater than a second surface area of a bottom of the piston 405. Thus, the first surface area over which the pressure is applied to the piston 405 in the dome 440 (e.g., applied to the top of the piston 405) may be greater than (e.g., larger than) the second surface area over which the pressure is applied to the piston 405 in the inlet 170 (e.g., applied to the bottom of the piston 405), such that a first force applied to the piston 405 by the fluid in the dome 440 (e.g., in a first direction) may be greater than a second force applied to the piston 405 by the fluid in the inlet 170 (e.g., in a second direction), restricting the piston 405 from moving (e.g., in the second direction).

Conversely, when the pressure of the fluid (e.g., at the inlet 170, in the pilot valve 450) meets or exceeds the threshold pressure (e.g., set pressure), the sense diaphragm 430 may move to an open position, allowing the fluid to flow (e.g., vent) through the exhaust 425. The fluid flowing out of the exhaust 425 may relieve a portion of the pressure of the fluid in the dome 440, such that the pressure of the fluid in the dome 440 becomes less than the pressure of the fluid in the inlet 170, resulting in an upward net force (e.g., a net force in the second direction) that causes the piston 405 to lift. In other words, when fluid is flowing out of the exhaust 425, the fluid in the dome 440 may be associated with a lower pressure than the fluid in the inlet 170, such that a third force applied to the piston 405 by the fluid in the dome 440 is less than a fourth force applied to the piston 405 by the fluid in the inlet 170, allowing the piston 405 to move to the open position (e.g., in the second direction), as depicted in FIG. 4B. In the open position, at least part of the portion of the piston 405 (e.g., including the orifices 155) previously positioned in the one or more annular grooves 445 may be position above the one or more annular grooves 445, such that at least a subset of the orifices 155 are no longer position within the one or more annular grooves 445. Thus, the fluid (e.g., the rest of the fluid not flowing to the pilot valve 450) may flow from the inlet 170 through the at least subset of the orifices 155 to the outlet chamber 165. As described with reference to FIGS. 1A, 1B, and 1C, the orifices 155 may split a single flow of fluid into the piston 405 into multiple flows of fluid out of the piston 405, reducing AIV and noise (e.g., as compared to a single flow of fluid from the inlet 170 to the outlet 175). After the pressure of the fluid returns to below the threshold pressure (e.g., after an overpressure event), the pilot valve 450 may close the sense diaphragm 430, thus restricting (e.g., preventing) flow of the fluid through the exhaust 425 and re-establishing pressure in the dome 440. Re-establishment of the pressure (e.g., pressure less than the threshold pressure) in the dome 440 may result in the fluid in the dome 440 applying the first force the piston 405 (e.g., which is greater than the second force applied to the piston 405 by the fluid in the inlet 170), causing the piston 405 to reseat (e.g., close).

In some cases, as depicted in FIG. 4B, the POPRV 400 may be a first type of POPRV 400 (e.g., a snap-open POPRV 400) in which the open position may be associated with all of the orifices 155 being positioned above (e.g., out of) the one or more annular grooves 445. In other words, when the pressure of the fluid at the inlet 170 is greater than the threshold pressure, the piston 405 may transition from none of the orifices 155 being positioned above (e.g., outside of, out of) the one or more annular grooves 445 to all of the orifices 155 being positioned above the one or more annular grooves 445 (e.g., the fluid may flow through all of the orifices 155). In some other cases (e.g., not depicted), the POPRV 400 may be a second type of POPRV 400 (e.g., a modulating POPRV 400) in which the open position may be associated with at least a subset of the orifices 155 being positioned above the one or more annular grooves 445. In other words, when the pressure of the fluid at the inlet 170 is greater than the threshold pressure, the piston 405 may transition from none of the orifices 155 being positioned above the one or more annular grooves 445 to at least a subset of the orifices 155 being positioned above the one or more annular grooves 445 (e.g., the fluid may flow through the at least subset of the orifices 155), where an amount of movement of the piston 405 (e.g., how many orifices 155 are positioned above the one or more annular grooves 445) may be based on the pressure of the fluid at the inlet 170 (e.g., how much the pressure of the fluid at the inlet 170 exceeds the threshold pressure). Thus, an open position of the piston 405 in the second type of POPRV 400 may be within a range of open positions, where a first bound of the range is an open position in which at least one orifice 155 is positioned above the one or more annular grooves 445 and a second bound of the range may be an open position in which all of the orifices 155 are positioned above the one or more annular grooves 445.

Additionally, or alternatively, as described with reference to FIGS. 2A and 2B, the outlet chamber 165 may include multiple plates 285, where each plate 285 includes one or more orifices 255, such that a pressure of the fluid in the outlet chamber 165 may incrementally drop across each plate 285, rather than via a single pressure drop across the outlet chamber 165, reducing AIV and noise (e.g., as compared to AIV and noise associated with the single pressure drop). In some cases, one or more first characteristics associated with the flow splitting chamber 160 may be based on one or more second characteristics associated with the multiple plates 285, as described with reference to FIG. 3. Additionally, or alternatively, the one or more first characteristics associated with the flow splitting chamber 160, the one or more second characteristics associated with the multiple plates 285, or both, may be based on a type of the POPRV 400.

The following provides an overview of aspects of the present disclosure:

Aspect 1: A PRV, comprising: a nozzle configured to direct a flow of fluid from an inlet of the nozzle towards an outlet of the nozzle, wherein a seat is positioned at the outlet of the nozzle; a disc system configured to move from a closed position to an open position based at least in part on a pressure at the inlet of the nozzle exceeding a threshold pressure, wherein at least a portion of an inner circumference of the disc system is positioned around at least a portion of an outer circumference of the nozzle, wherein the disc system is configured to restrict the fluid from flowing from the nozzle through a plurality of orifices in a flow splitting chamber in the closed position, and wherein the disc system is configured to allow the fluid to flow from the nozzle through the plurality of orifices in the flow splitting chamber in the open position, the disc system further comprising: the flow splitting chamber comprising the plurality of orifices that are configured to split the flow of the fluid through the nozzle from a single flow to a plurality of flows when the disc system is in the open position, wherein both a first level of acoustic induced vibration and a first level of noise associated with the plurality of flows are less than a second level of acoustic induced vibration and a second level of noise, respectively, associated with the single flow; and a disc positioned within the flow splitting chamber, and configured to contact the seat in the closed position and to be a threshold distance from the seat in the open position, wherein the threshold distance is based at least in part on a position of the plurality of orifices in the flow splitting chamber; a spring coupled to the disc system and configured to enable the disc system to move from the closed position to the open position based at least in part on movement of the spring due to a compressive force exceeding a threshold force when the pressure in the nozzle exceeds the threshold pressure; a stem coupled to the spring and configured to align the spring with the disc system; and an outlet chamber configured to direct flow from the plurality of orifices through an outlet of PRV when the disc system is in the open position.

Aspect 2: The PRV of aspect 1, wherein a first area of the inlet of the nozzle is within a threshold deviation of a sum of respective second areas of the plurality of orifices.

Aspect 3: The PRV of any of aspects 1 through 2, wherein both the first level of acoustic induced vibration and the first level of noise associated with the plurality of flows being less than the second level of acoustic induced vibration associated and the second level of noise, respectively, with the single flow is based at least in part on a distance between each of the plurality of orifices exceeding a threshold distance.

Aspect 4: The PRV of any of aspects 1 through 3, wherein the plurality of orifices comprises one or more rows of orifices spaced vertically along a length of the flow splitting chamber, and both the first level of acoustic induced vibration and the first level of noise associated with the plurality of flows are based at least in part on a location of each of the one or more rows along the length of the flow splitting chamber.

Aspect 5: The PRV of aspect 4, wherein a first distance between a first row of orifices of the one or more rows of orifices and a second row of orifices of the one or more rows of orifices is different than a second distance between the second row of orifices and a third row of orifices of the one or more rows of orifices.

Aspect 6: The PRV of any of aspects 4 through 5, wherein a first distance between a first row of orifices of the one or more rows of orifices and a second row of orifices of the one or more rows of orifices is the same as a second distance between the second row of orifices and a third row of orifices of the one or more rows of orifices.

Aspect 7: The PRV of any of aspects 1 through 6, wherein the plurality of orifices are associated with a plurality of different sizes, and both the first level of acoustic induced vibration and the first level of noise associated with the plurality of flows are based at least in part on the plurality of different sizes.

Aspect 8: The PRV of aspect 7, wherein one or more of the plurality of orifices across a length of the flow splitting chamber have a different size compared to one or more other orifices of the plurality of orifices.

Aspect 9: The PRV of any of aspects 1 through 8, wherein at least a subset of the plurality of orifices are at a non-orthogonal angle relative to an outer surface of the flow splitting chamber, and both the first level of acoustic induced vibration and the first level of noise associated with the plurality of flows are based at least in part on the non-orthogonal angle relative to the outer surface of the flow splitting chamber.

Aspect 10: The PRV of any of aspects 1 through 9, wherein the plurality of orifices have one or more shapes including at least one of circular, square, hexagonal, oval, or triangular, and both the first level of acoustic induced vibration and the first level of noise associated with the plurality of flows are based at least in part on the one or more shapes of the plurality of orifices.

Aspect 11: The PRV of any of aspects 1 through 10, further comprising: a balancing system configured to reduce movement of the PRV due to differences in first flow rates associated with the plurality of flows.

Aspect 12: The PRV of aspect 11, wherein the balancing system comprises one or more pistons, one or more bellows, one or more diaphragms, or any combination thereof.

Aspect 13: The PRV of any of aspects 1 through 12, wherein first flow rates associated with the plurality of flows are the same.

Aspect 14: The PRV of any of aspects 1 through 13, wherein the fluid is a gas, a vapor, or a steam.

Aspect 15: A PRV, comprising: a nozzle configured to direct a flow of fluid from an inlet of the nozzle through an outlet of the nozzle, wherein a seat is positioned at the outlet of the nozzle; a disc system configured to move from a closed position to an open position based at least in part on a pressure of the fluid at the inlet of the nozzle exceeding a threshold pressure, wherein the closed position restricts the fluid from flowing from the nozzle to an outlet chamber, and wherein the open position allows the fluid to flow from the nozzle to the outlet chamber; a spring coupled to the disc system and configured to enable the disc system to move from the closed position to the open position based at least in part on movement of the spring due to a compressive force from a fluid exceeding a threshold force when the pressure of the fluid in the nozzle exceeds the threshold pressure; a stem coupled to the spring and configured to align the spring with the disc system; and an outlet chamber configured to direct flow from the nozzle through an outlet of the PRV when the disc system is in the open position, wherein the outlet chamber comprises: a plurality of staged plates positioned across a length of the outlet chamber, wherein each staged plate from the plurality of staged plates comprises one or more orifices from a plurality of orifices, wherein each staged plate is associated with a respective pressure drop of the fluid from a plurality of pressure drops of the fluid, wherein both a first level of acoustic induced vibration and a first level of noise associated with the plurality of pressure drops are less than a second level of acoustic induced vibration and a second level of noise, respectively, associated with a single pressure drop across the outlet chamber.

Aspect 16: The PRV of aspect 15, wherein both the first level of acoustic induced vibration and the first level of noise associated with the plurality of pressure drops are based at least in part on a distance between each staged plate of the plurality of staged plates.

Aspect 17: The PRV of any of aspects 15 through 16, wherein at least a subset of the plurality of orifices are offset from each other, and the plurality of pressure drops are based at least in part on the plurality of orifices being offset from each other.

Aspect 18: The PRV of any of aspects 15 through 17, wherein at least a subset of the plurality of orifices have different sizes, and the plurality of pressure drops are based at least in part on the different sizes of at least the subset of the plurality of orifices.

Aspect 19: The PRV of aspect 18, wherein the plurality of orifices change in size across a length of the outlet chamber.

Aspect 20: The PRV of any of aspects 15 through 19, wherein the plurality of orifices are associated with one or more shapes including at least one of circular, square, hexagonal, oval, or triangular, and the plurality of pressure drops is based at least in part on the one or more shapes.

Aspect 21: The PRV of any of aspects 15 through 20, wherein at least a subset of the plurality of orifices are at a non-orthogonal angle relative to a respective outer surface of a staged plate from the plurality of staged plates, and the plurality of pressure drops are based at least in part on the non-orthogonal angle.

Aspect 22: The PRV of any of aspects 15 through 21, wherein at least a subset of the plurality of staged plates are at a non-orthogonal angle relative to the outlet of the PRV.

Aspect 23: The PRV of any of aspects 15 through 22, wherein a respective distance between each staged plate of at least a subset of the plurality of staged plates is different.

Aspect 24: The PRV of any of aspects 15 through 23, wherein a respective distance between each staged plate of at least a subset of the plurality of staged plates is the same.

Aspect 25: The PRV of any of aspects 15 through 24, wherein the fluid is a gas, a vapor, or a steam.

Aspect 26: A PRV, comprising: a nozzle configured to direct a flow of fluid from an inlet of the nozzle through an outlet of the nozzle, wherein a seat is positioned at the outlet of the nozzle; a disc system configured to move from a closed position to an open position based at least in part on a pressure at the inlet of the nozzle exceeding a threshold pressure, wherein at least a portion of an inner circumference of the disc system is positioned around at least a portion of an outer circumference of the nozzle, wherein the disc system is configured to restrict the fluid from flowing from the nozzle through a plurality of first orifices in a flow splitting chamber in the closed position, and wherein the disc system is configured to allow the fluid to flow from the nozzle through the plurality of first orifices in the flow splitting chamber in the open position, the disc system further comprising: the flow splitting chamber comprising the plurality of first orifices that are configured to split the flow of the fluid through the nozzle from a single flow to a plurality of flows when the disc system is in the open position, wherein both a first level of acoustic induced vibration and a first level of noise associated with the plurality of flows are less than a second level of acoustic induced vibration and a second level of noise, respectively, associated with the single flow; and a disc positioned within the flow splitting chamber and configured to contact the seat in the closed position and to be a threshold distance from the seat in the open position, wherein the threshold distance is based at least in part on a position of the plurality of first orifices in the flow splitting chamber; a spring coupled to the disc system and configured to enable the disc system to move from the closed position to the open position based at least in part on movement of the spring due to a compressive force exceeding a threshold force when the pressure in the nozzle exceeds the threshold pressure; a stem coupled to the spring and configured to align the spring with the disc system; and an outlet chamber configured to direct flow from the nozzle through an outlet of the PRV when the disc system is in the open position, wherein the outlet chamber comprises: a plurality of staged plates positioned across a length of the outlet chamber, wherein each staged plate from the plurality of staged plates comprises one or more second orifices from a plurality of second orifices, wherein each staged plate is associated with a respective pressure drop of the fluid from a plurality of pressure drops of the fluid, wherein both a third level of acoustic induced vibration and a third level of noise associated with the plurality of pressure drops are less than a fourth level of acoustic induced vibration and a fourth level of noise, respectively, associated with a single pressure drop across the outlet chamber.

Aspect 27: The PRV of aspect 26, wherein a distance between the flow splitting chamber and a first stage plate of the plurality of staged plates, a quantity of the plurality of second orifices, a quantity of the plurality of staged plates, or any combination thereof, are based at least in part on one or more characteristics of the plurality of first orifices.

Aspect 28: The PRV of aspect 27, wherein the one or more characteristics comprise a quantity of the plurality of first orifices, the position of the plurality of first orifices in the flow splitting chamber, one or more sizes associated with the plurality of first orifices, one or more shapes associated with the plurality of first orifices, or any combination thereof.

Aspect 29: The PRV of any of aspects 26 through 28, wherein a quantity of the plurality of first orifices is based at least in part on one or more first characteristics of the plurality of staged plates, one or more second characteristics of the plurality of second orifices, or both.

Aspect 30: The PRV of aspect 29, wherein the one or more first characteristics comprise a quantity of the plurality of second orifices, respective positions of the plurality of second orifices, one or more sizes associated with the plurality of second orifices, one or more shapes associated with the plurality of second orifices, or any combination thereof, and the one or more second characteristics comprise a quantity of the plurality of staged plates, respective positions of the plurality of staged plates, or both.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A pressure relief value (PRV), comprising:
a nozzle configured to direct a flow of fluid from an inlet of the nozzle towards an outlet of the nozzle, wherein a seat is positioned at the outlet of the nozzle;
a disc system configured to move from a closed position to an open position based at least in part on a pressure at the inlet of the nozzle exceeding a threshold pressure, wherein at least a portion of an inner circumference of the disc system is positioned around at least a portion of an outer circumference of the nozzle, wherein the disc system is configured to restrict the fluid from flowing from the nozzle through a plurality of orifices in a flow splitting chamber in the closed position, and wherein the disc system is configured to allow the fluid to flow from the nozzle through the plurality of orifices in the flow splitting chamber in the open position, the disc system further comprising:
the flow splitting chamber comprising the plurality of orifices that are configured to split the flow of the fluid through the nozzle from a single flow to a plurality of flows when the disc system is in the open position, wherein both a first level of acoustic induced vibration and a first level of noise associated with the plurality of flows are less than a second level of acoustic induced vibration and a second level of noise, respectively, associated with the single flow; and
a disc positioned within the flow splitting chamber, and configured to contact the seat in the closed position and to be a threshold distance from the seat in the open position, wherein the threshold distance is based at least in part on a position of the plurality of orifices in the flow splitting chamber;
a spring coupled to the disc system and configured to enable the disc system to move from the closed position to the open position based at least in part on movement of the spring due to a compressive force exceeding a threshold force when the pressure in the nozzle exceeds the threshold pressure;
a stem coupled to the spring and configured to align the spring with the disc system; and
an outlet chamber configured to direct flow from the plurality of orifices through an outlet of PRV when the disc system is in the open position.

2. The PRV of claim 1, wherein a first area of the inlet of the nozzle is within a threshold deviation of a sum of respective second areas of the plurality of orifices.

3. The PRV of claim 1, wherein both the first level of acoustic induced vibration and the first level of noise associated with the plurality of flows being less than the second level of acoustic induced vibration and the second level of noise, respectively, associated with the single flow is based at least in part on a distance between each of the plurality of orifices exceeding a threshold distance.

4. The PRV of claim 1, wherein the plurality of orifices comprises one or more rows of orifices spaced vertically along a length of the flow splitting chamber, and wherein both the first level of acoustic induced vibration and the first level of noise associated with the plurality of flows are based at least in part on a location of each of the one or more rows along the length of the flow splitting chamber.

5. The PRV of claim 4, wherein a first distance between a first row of orifices of the one or more rows of orifices and a second row of orifices of the one or more rows of orifices is different than a second distance between the second row of orifices and a third row of orifices of the one or more rows of orifices.

6. The PRV of claim 4, wherein a first distance between a first row of orifices of the one or more rows of orifices and a second row of orifices of the one or more rows of orifices is the same as a second distance between the second row of orifices and a third row of orifices of the one or more rows of orifices.

7. The PRV of claim 1, wherein the plurality of orifices are associated with a plurality of different sizes, and wherein both the first level of acoustic induced vibration and the first level of noise associated with the plurality of flows are based at least in part on the plurality of different sizes.

8. The PRV of claim 7, wherein one or more of the plurality of orifices across a length of the flow splitting chamber have a different size compared to one or more other orifices of the plurality of orifices.

9. The PRV of claim 1, wherein at least a subset of the plurality of orifices are at a non-orthogonal angle relative to an outer surface of the flow splitting chamber, and wherein both the first level of acoustic induced vibration and the first level of noise associated with the plurality of flows is based at least in part on the non-orthogonal angle relative to the outer surface of the flow splitting chamber.

10. The PRV of claim 1, wherein the plurality of orifices have one or more shapes including at least one of circular, square, hexagonal, oval, or triangular, and wherein both the first level of acoustic induced vibration and the first level of noise associated with the plurality of flows are based at least in part on the one or more shapes of the plurality of orifices.

11. The PRV of claim 1, further comprising:
a balancing system configured to reduce movement of the PRV due to differences in first flow rates associated with the plurality of flows.

12. The PRV of claim 11, wherein the balancing system comprises one or more pistons, one or more bellows, one or more diaphragms, or any combination thereof.

13. The PRV of claim 1, wherein first flow rates associated with the plurality of flows are the same.

14. The PRV of claim 1, wherein the fluid is a gas, a vapor, or a steam.

15. A pressure relief value (PRV), comprising:
a nozzle configured to direct a flow of fluid from an inlet of the nozzle through an outlet of the nozzle, wherein a seat is positioned at the outlet of the nozzle;
a disc system configured to move from a closed position to an open position based at least in part on a pressure of the fluid at the inlet of the nozzle exceeding a threshold pressure, wherein the closed position restricts the fluid from flowing from the nozzle to an outlet chamber, and wherein the open position allows the fluid to flow from the nozzle to the outlet chamber;
a spring coupled to the disc system and configured to enable the disc system to move from the closed position to the open position based at least in part on movement of the spring due to a compressive force from a fluid exceeding a threshold force when the pressure of the fluid in the nozzle exceeds the threshold pressure;
a stem coupled to the spring and configured to align the spring with the disc system; and
an outlet chamber configured to direct flow from the nozzle through an outlet of the PRV when the disc system is in the open position, wherein the outlet chamber comprises:
a plurality of staged plates positioned across a length of the outlet chamber, wherein each staged plate from the plurality of staged plates comprises one or more orifices from a plurality of orifices, wherein each staged plate is associated with a respective pressure drop of the fluid from a plurality of pressure drops of the fluid, wherein both a first level of acoustic induced vibration and a first level of noise associated with the plurality of pressure drops are less than a second level of acoustic induced vibration and a second level of noise, respectively, associated with a single pressure drop across the outlet chamber.

16. The PRV of claim 15, wherein both the first level of acoustic induced vibration and a first level of noise associated with the plurality of pressure drops are based at least in part on a distance between each staged plate of the plurality of staged plates.

17. The PRV of claim 15, wherein at least a subset of the plurality of orifices are offset from each other, and wherein the plurality of pressure drops are based at least in part on the plurality of orifices being offset from each other.

18. The PRV of claim 15, wherein at least a subset of the plurality of orifices have different sizes, and wherein the plurality of pressure drops are based at least in part on the different sizes of at least the subset of the plurality of orifices.

19. The PRV of claim 18, wherein the plurality of orifices change in size across a length of the outlet chamber.

20. The PRV of claim 15, wherein the plurality of orifices are associated with one or more shapes including at least one of circular, square, hexagonal, oval, or triangular, and wherein the plurality of pressure drops is based at least in part on the one or more shapes.

21. The PRV of claim 15, wherein at least a subset of the plurality of orifices are at a non-orthogonal angle relative to a respective outer surface of a staged plate from the plurality of staged plates, and wherein the plurality of pressure drops are based at least in part on the non-orthogonal angle.

22. The PRV of claim 15, wherein at least a subset of the plurality of staged plates are at a non-orthogonal angle relative to the outlet of the PRV.

23. The PRV of claim 15, wherein a respective distance between each staged plate of at least a subset of the plurality of staged plates is different.

24. The PRV of claim 15, wherein a respective distance between each staged plate of at least a subset of the plurality of staged plates is the same.

25. The PRV of claim 15, wherein the fluid is a gas, a vapor, or a steam.

26. A pressure relief value (PRV), comprising:
a nozzle configured to direct a flow of fluid from an inlet of the nozzle through an outlet of the nozzle, wherein a seat is positioned at the outlet of the nozzle;
a disc system configured to move from a closed position to an open position based at least in part on a pressure at the inlet of the nozzle exceeding a threshold pressure, wherein at least a portion of an inner circumference of the disc system is positioned around at least a portion of an outer circumference of the nozzle, wherein the disc system is configured to restrict the fluid from flowing from the nozzle through a plurality of first orifices in a flow splitting chamber in the closed position, and wherein the disc system is configured to allow the fluid to flow from the nozzle through the plurality of first orifices in the flow splitting chamber in the open position, the disc system further comprising:
the flow splitting chamber comprising the plurality of first orifices that are configured to split the flow of the fluid through the nozzle from a single flow to a plurality of flows when the disc system is in the open position, wherein both a first level of acoustic induced vibration and a first level of noise associated with the plurality of flows are less than a second level of acoustic induced vibration and a second level of noise, respectively, associated with the single flow; and
a disc positioned within the flow splitting chamber and configured to contact the seat in the closed position and to be a threshold distance from the seat in the open position, wherein the threshold distance is based at least in part on a position of the plurality of first orifices in the flow splitting chamber;
a spring coupled to the disc system and configured to enable the disc system to move from the closed position to the open position based at least in part on movement of the spring due to a compressive force exceeding a threshold force when the pressure in the nozzle exceeds the threshold pressure;
a stem coupled to the spring and configured to align the spring with the disc system; and
an outlet chamber configured to direct flow from the nozzle through an outlet of the PRV when the disc system is in the open position, wherein the outlet chamber comprises:
a plurality of staged plates positioned across a length of the outlet chamber, wherein each staged plate from the plurality of staged plates comprises one or more second orifices from a plurality of second orifices, wherein each staged plate is associated with a respective pressure drop of the fluid from a plurality of pressure drops of the fluid, wherein both a third level of acoustic induced vibration and a third level of noise associated with the plurality of pressure drops are less than a fourth level of acoustic induced vibration and a fourth level of noise, respectively, associated with a single pressure drop across the outlet chamber.

27. The PRV of claim 26, wherein a distance between the flow splitting chamber and a first stage plate of the plurality of staged plates, a quantity of the plurality of second orifices, a quantity of the plurality of staged plates, or any combination thereof, are based at least in part on one or more characteristics of the plurality of first orifices.

28. The PRV of claim 27, wherein the one or more characteristics comprise a quantity of the plurality of first orifices, the position of the plurality of first orifices in the flow splitting chamber, one or more sizes associated with the plurality of first orifices, one or more shapes associated with the plurality of first orifices, or any combination thereof.

29. The PRV of claim 26, wherein a quantity of the plurality of first orifices is based at least in part on one or more first characteristics of the plurality of staged plates, one or more second characteristics of the plurality of second orifices, or both.

30. The PRV of claim 29, wherein the one or more first characteristics comprise a quantity of the plurality of second orifices, respective positions of the plurality of second orifices, one or more sizes associated with the plurality of second orifices, one or more shapes associated with the plurality of second orifices, or any combination thereof, and wherein the one or more second characteristics comprise a quantity of the plurality of staged plates, respective positions of the plurality of staged plates, or both.
